(19) United States
(12) Patent Application Publication
(10) Pub. No.: US 2023/0175841 A1
(43) Pub. Date: Jun. 8, 2023

(54) COMPUTER VISION AND LASER BASED SYSTEM FOR MACHINE ALIGNMENT

(71) Applicant: Xerxes Maximilian Libsch, White Plains, NY (US)

(72) Inventor: Xerxes Maximilian Libsch, White Plains, NY (US)

(21) Appl. No.: 17/922,147

(22) PCT Filed: Apr. 28, 2021
(86) PCT No.: PCT/US2021/029745

§ 371 Date: Oct. 28, 2022

Related U.S. Application Data
(60) Provisional application No. 63/016,435, filed on Apr. 28, 2020.

(51) Int. Cl. G01B 11/27

(52) U.S. Cl. CPC G01B 11/272

(57) ABSTRACT

The disclosed device, system and method allows for real-time axial alignment of a machine containing one or more axes that are driven by a motor. The axes can be rotational or linear. The system uses a plurality of lasers or equivalent optical emitters along with a detector camera in order to quantify alignment of the given axis with respect to a common plane, by means of providing the angular displacement of the axis from the axis normal to the plane. The system is insensitive to the relative angle of the detector plane. Furthermore, the device, system and method additionally provide self-correcting measures in the case that one or more of the lasers is out of alignment itself, so as to provide robustness to misalignment itself. In addition to the plurality of lasers or equivalent optical emitters and detector array, the device contains a feedback system to act upon error signals proportional to the degree of misalignment. The plurality of lasers and one or more cameras and feedback systems can be included in a system that includes hardware and software to process the data from the camera. The disclosed invention encompasses the device, system and methodology that are insensitive to disturbances of the system itself for both determining angular alignment of a given axis as well as the methodology for correcting for the given angular misalignment so that the axis is effectively aligned.

### CROSS-REFERENCE TO RELATED APPLICATIONS

The present application is the nationalization of PCT Application PCT/US2021/029745, filed Apr. 28, 2021, published as WO2021222470A1 on Nov. 11, 2021, said application incorporated herein by reference in its entirety. PCT Application PCT/US2021/029745 is a PCT international application of and claims the benefit of U.S. Provisional Application No. 63/016,435, filed Apr. 28, 2020, which is incorporated herein by reference in its entirety.

### BACKGROUND OF THE INVENTION

There are several prior art devices.

Optical Alignment Method and System, US7184136B2. Disclosed systems and methods allow for angular orientation of collimator relative to an electro-optical system and for aligning the two.

Laser Boresighting Method and Apparatus, US3628868A. Disclosed systems and methods allow for a telescope that is mounted with a laser in order to boresight the telescope to the laser using a parabolic reflector with a four-quadrant photodetector.

Laser Target Designator Tester for Measuring Static and Dynamic Error, US5506675A. Disclosed systems and methods allow for a method of testing a laser target designator in which an aperture in the field of view has one size facing the target image detector and a video processor obtains a test video image from the beam image detector and computes the centroid of the aperture and centroid of laser.

Optical Monitoring Device for an imaging System, US20140198222A1. Disclosed systems allow for an optical monitoring device with a focal plane and entry pupil that forms an image of a scene on an image detector to allow for optical defects to be identified.

Optical Alignment Apparatus, US4621924A. Disclosed systems allow for an apparatus for indicating misalignment of optical elements that has a beam splitter that divides the beam inputs, as well as an off-axis beam sampling device.

Method and Apparatus for Optical Alignment (US9817203B2). Various embodiments include methods, systems and apparatus for optically aligning multiple sensors using prismatic elements.

Laser Alignment System, US6308428B1. Disclosed system and methods allow for an alignment system that includes a laser transmitter and receiver comprised of a photodetector array centered at a predetermined location with respect to machined surfaces that define a receiver reference plane.

Machines, robots and mechanical devices are ubiquitous. In general, such machines have axes of motion along which they can move. These axes of motion however can be misaligned due to external disturbances or poor manufacturing of the machine. In such a case, the misalignment of the particular axis and corresponding actuation system diverges from the intended path of actuation. This causes errors and prevents the axis from achieving its intended goal.

Thus, it is beneficial to be able to measure such misalignment, so that the misalignment can be corrected for. Furthermore, real time characterization of the misalignment allows for dynamic and continuous re-adjustment of the machine axis so that effective alignment can be achieved.

In general, a wide array of applications benefit from quantifying the degree of alignment of a particular machine axis. In addition, a wide array of applications benefit from utilizing quantities of misalignment characterization to provide correction for the misalignment.

In the field of manufacturing, machines require a great degree of precision. For example, printed circuit board (PCB) manufacturing machines require the use of precise positioning that is highly sensitive to alignment.

In the field of medical and surgical robotics, alignment characterization and corresponding action that is taken to resolve the misalignment is extremely important. For example, surgical robots that perform automated surgery rely on precise alignment of machine axes in order to perform successful surgeries. In addition, intravenous injection robots, which utilize an array of axes and actuation and can insert a needle or equivalent device into a vein or artery require alignment and precision in order to insert into the correct location along the vein. In such cases, misalignment of an insertion axis of the machine could lead to poor results and danger to a patient.

In U.S. Pat. No. US9817203B2 (Method and Apparatus for Optical Alignment System) includes methods systems and apparatus for optically aligning multiple sensors. However, the system requires prismatic elements, and furthermore does not account for variation in the alignment of the sensors themselves.

In U.S. Pat. No. US4621924A (Optical Alignment Apparatus), an apparatus for indicating optical elements that has a beam splitter and that divides the beam inputs as well as an off-axis beam sampling device is presented. However, the apparatus does not account for variation of error in real time and requires a beam splitting mechanism. In addition, the apparatus does not include correcting principles of the optical elements.

In U.S. Pat. No. US5506675A, a method of testing a laser target designator in which an aperture in the field of view has one size facing the target image detector and a video processor obtains a test video image from the beam image detector and computes the centroid of the aperture and centroid of laser is presented. However, the system is sensitive to the alignment of the laser target designator itself, and does not present methods to eliminate sensitivity to intrinsic machine alignment.

Despite prior approaches, there still exists a great need for a device, system and methodology with a greater range of performance and generality that is not sensitive to the alignment of the lasers used for alignment detection. The systems described have several major limitations that are not addressed in the general prior art.

First, the systems described are sensitive to detector angle. The systems utilize one or more detectors in order to measure the angle and position of laser or other light. These detectors require precise alignment, which cannot always be achieved. In addition, precise alignment is subject to disturbances that can render alignment results useless. One of the goals of this invention is to address this limitation.

Second, the systems described are sensitive to alignment errors of the laser or equivalent light emitters themselves. The systems require precise alignment of the laser or other light, which cannot always be achieved. In addition, the alignment of these lasers are subject to change over time, which can render alignment results functionally useless until the device is realigned. One of the goals of this invention is to address this limitation.

Third, the systems do not provide a means of arbitrarily attaching hardware components to axes of motion such that the alignment between the hardware attachment and the axis of motion can be determined.

The ultimate goal of this invention is to address the fundamental limitations aforementioned in the prior art.

### SUMMARY OF THE INVENTION

The disclosed device, system and method allows for real-time axial alignment of a machine containing one or more axes that are driven by a motor. The axes can be rotational or linear. The system uses a plurality of lasers or equivalent optical emitters along with a detector camera in order to quantify alignment of the given axis with respect to a common plane, by means of providing the angular displacement of the axis from the axis normal to the plane. The system is insensitive to the relative angle of the detector plane. Furthermore, the device, system and method additionally provide self-correcting measures in the case that one or more of the lasers is out of alignment itself, so as to provide robustness to misalignment itself. In addition to the plurality of lasers or equivalent optical emitters and detector array, the device contains a feedback system to act upon error signals proportional to the degree of misalignment. The plurality of lasers and one or more cameras and feedback systems can be included in a system that includes hardware and software to process the data from the camera. The disclosed invention encompasses the device, system and methodology that are insensitive to disturbances of the system itself for both determining angular alignment of a given axis as well as the methodology for correcting for the given angular misalignment so that the axis is effectively aligned.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a schematic of the device according to an embodiment of the present invention, for real-time self-correcting axial alignment of a machine containing one or more axes.

FIG. 2 is a schematic of the system according to an embodiment of the present invention, for real-time self-correcting axial alignment of a machine containing one or more axes.

FIG. 3a: is a schematic of the system according to an embodiment of the present invention, for real-time self-correcting axial alignment of a machine containing one or more axes.

FIG. 3b: is a schematic of the system according to an embodiment of the present invention, for real-time self-correcting axial alignment of a machine containing one or more axes.

FIG. 3c: is a schematic of the system according to an embodiment of the present invention, for real-time self-correcting axial alignment of a machine containing one or more axes.

FIG. 4: is a diagram of different laser geometries with respect to a camera detector.

FIG. 5: is a diagram of different laser and camera detector geometries with respect to a 2D planar surface

FIG. 6: is a diagram of different laser projection geometries with respect to a 2D planar surface.

### DETAILED DESCRIPTION OF THE INVENTION

### Device - Embodiment 1

The ultimate goal of this invention is to address the fundamental limitations aforementioned. One or more embodiments of the invention address these and other needs by providing a fundamentally different approach to providing laser based alignment between an axis of motion and a given reference plane as well as the axis of motion and a plurality of modular hardware attachments that are functionally attached to the axis of motion. The embodiment EMBODIMENT 1 shows a device that moves along two given axes of motion, wherein one is linear, and one is rotational. The device contains a plurality of lasers, wherein the plurality of lasers can be further segmented into multiple sub-groups. Each laser is functionally coupled to the axis of motion with some arbitrary orientation, that is allowed to change over time or motion along each of the axes of motion. In addition, the device contains a modular hardware attachment that is functionally coupled to the axis of motion, as well as a camera that is functionally coupled to the axis of motion. The modular hardware attachment contains a sub-group of laser emitting devices that are functionally coupled to it. The plurality of lasers of the device are allowed to emit any wavelength of light from 100 nm to 1 mm.

### System - Embodiment 2

One embodiment of the present invention is shown in EMBODIMENT 2. The device of EMBODIMENT 1 is augmented in a system with numerous features. There are three main feature differences with respect to EMBODIMENT 1. First, EMBODIMENT 2 shows the functional device from EMBODIMENT 1 attached to a set of motion axes, wherein the motion axes are responsible for movement of the device shown in EMBODIMENT 1 along both a rotational and linear set of axes. The motion axes are driven by motors, and functionally attached to each other using a linear rail guide and mounting brackets. The linear axis is responsible for translating the whole rotary axis along with the device from EMBODIMENT 1 in a linear fashion along its axis. The rotary axis is directly coupled to the device from EMBODIMENT 1 and allows the device from EMBODIMENT 1 to be translated rotationally in either direction (clockwise or counterclockwise). It is mounted on the linear rail guide, and features a lead screw that allows the linear motion from the linear axis to be sufficiently translated in order to mobilize the rotational axis as well as the device from EMBODIMENT 1. Second, the device from EMBODIMENT 1 is augmented with a modular hardware attachment that contains a probe and wherein the probe is hollow and capable of liquid transport through its hollow cavity. Third, the device from EMBODIMENT 1 is augmented such that it features a rigid base which houses a microcontroller or similar means of handling input, output and data processing. The microcontroller is capable of utilizing memory and algorithms.

### Process - Embodiment 3a

Another embodiment of the present invention relates to the process by which the alignment of a set of one or more motion axes that contain one or more functionally coupled plurality of lasers as well as a camera and supporting modular hardware attachments can be determined. In addition to EMBODIMENT 2, signal input from the camera would be received by the microcontroller. In addition the microcontroller would have control over laser signal transmittance, such that the signal for any arbitrary number of groups within the total plurality of the lasers could be controlled.

An object of the current invention is to provide a method for the determination of the alignment between each of one or more motion axes and a common reference plane, as well as each motion axis and hardware groups that are functionally attached to each motion axis. First, the plurality of lasers must be pulsed in distinct groups, with each group corresponding to the sub-group of lasers functionally attached to each axis of motion as well as each modular hardware attachment attached to each axis. Distinct pulsing can is viewed continuously by the camera, and for each group within the plurality of lasers, a centroid of each laser group is computed. This centroid adds robustness to the individual alignment variation of each laser. In addition, this is robust to camera alignment so long as the laser projections onto a common reference surface are visible by the camera, as camera position is fixed at some arbitrary alignment which does not affect the geometry of the laser projections onto a common reference plane. Alignment between axis and hardware groups is then obtained by comparison of the difference between distance between centroid projections depending on the distance of the common projection surface.

### Process - Embodiment 3b

Another object of the current invention is to provide a method for the determination of alignment of each sub-group of the laser total laser plurality relative to arbitrary motion path of one or more axes. Referring to EMBODIMENT 3, this could concern for example, the tracking of a particular reference position on a projection surface normal to the axis of linear motion such that the hollow probe could be positioned directly over the reference target even thought the system is subject to both axis alignment variation error as well as alignment variation between each given axis and modular hardware components (such as the probe). This alignment relative to the motion path is achieved by first pulsing the lasers in distinct groups, with each group corresponding to the sub-group of lasers functionally attached to each axis of motion as well as each modular hardware attachment attached to each axis. Distinct pulsing can is viewed continuously by the camera, and for each group within the plurality of lasers, a centroid of each laser group is computed. This centroid is then computed at each motion step along the motion profile of one or more motion axes. The relative centroid differentials between laser sub-groups as a function of motion step can thus be determined. This allows for re-adjustment of the axis position in order to account for the difference, such that for example a common target point for the probe can be achieved.

### Process - Embodiment 3c

In addition, an object of the current invention is to obtain the alignment of each laser plurality such that the alignment system over time or axis motion can be determined. This addresses a fundamental limitation in the prior art devices, wherein the alignment parameters of a laser system was known, and then the known alignment is used to then achieve device alignment. However, if the given device alignment changes, the device must be realigned. In order to solve this limitation in the prior art, alignment of each laser plurality itself is obtained such that the differences over time and axis travel can be known and thus accounted for. In order to do this, the same emittance and detection process is performed as aforementioned, except in this case that for each sub-group of n different lasers (corresponding to a particular axis or modular hardware attachment), a further subgroup of all n-1 permutations within the subgroup is pulsed emitted and detected. This allows for the determination of the alignment as a function of a particular laser over time and motion, which allows for device correction in order to eliminate positional error of a particular axis due to this variation in the alignment system itself.

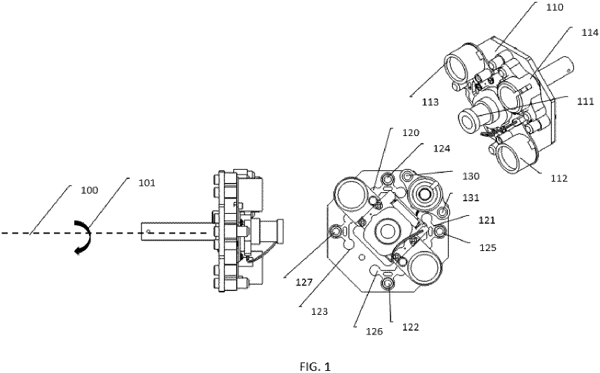

A further description of the example embodiments of the invention follows. Embodiments of the claimed invention can be first explained with reference to FIG. 1.

FIG. 1 is a schematic of the device according to an embodiment of the present invention, for real-time self-correcting axial alignment of a machine containing one or more axes. A hardware platform (110) is allowed to move along two axes. First, it is allowed to rotate around a rotational axis (101) and then move along a linear axis (100). The device in addition contains a plurality of one or more lasers (124, 125, 126, 127, 130, 131) capable of emitting any wavelength of light from 100 nm to 1 mm that are functionally coupled to the axes of motion (100, 101). The lasers are rigidly coupled by means of modular hardware attachments (120, 121, 122, 123). The lasers are further subdivided into two functional groups, with 4 laser emitters (124, 125, 126 and 127) in one group that are rigidly attached to the hardware platform that follows the two axes of motion, and another group of 2 lasers (130, 131) that connected to a modular hardware attachment (114), which itself is free to move along the axes of motion. In addition, the hardware platform contains a camera (111) that is functionally coupled to the axis of motion, and also contains infrared light detectors (112, 113). The alignment between the axes of motion and a fixed reference plane are allowed to vary, and the alignment between the camera and the fixed reference plane are allowed to vary as well. In addition, the alignment of the plurality of lasers is allowed to vary with time as well as the motion path along the two given axes.

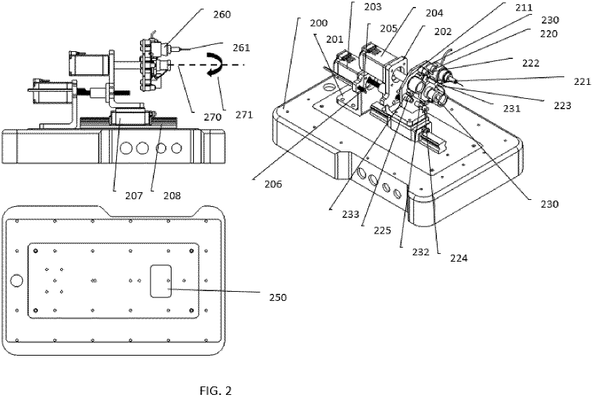

FIG. 2 is a schematic of the system according to an embodiment of the present invention, for real-time self-correcting axial alignment of a machine containing one or more axes. The schematic shows an actuated platform (211) that is functionally coupled to two axes of motion, (270, 271). The platform contains a plurality of lasers (220, 221, 222, 223, 224, 225), which are further subdivided into two groups. One group is attached to the actuated platform (222, 223, 224, 225) by means of mechanical fixtures (230, 231, 232, 233). The other group of laser emitters (220, 221) is attached to a modular hardware attachment (260). A camera assembly (230) is also rigidly attached to the platform. In addition, this system demonstrates the actuation method by which the actuated platform is actuated. This includes a system of two motors, (203, 204), one responsible for rotational movement along one axis (271) and one is responsible for linear movement along another axis (260). The motion is independent. The linear axis motor (203) generates linear motion by means of a lead screw (206). This lead screw is fixed to the rotating output shaft of the motor. The lead screw in turn translates the rotational output from the motor into linear motion that is translated through a rail (207) and carriage (208) system. The linear motor is fixed via a coupling bracket (201). The rotational axis motor is fixed to the linear rail carriage via another coupling bracket (202). This effectively translates the linear motion so that the platform can both undergo rotational as well as linear motion. The linear motion axis has a stop limit switch (205) such that the axis does not overextend. The system in addition has a hollow probe (260) that can transport fluid within its cavity, and is attached by means of a modular hardware attachment (260) that is functionally coupled to the axis of motion. In addition, the system has a microcontroller (250) that is housed within a base unit (200) for structural stabilization.

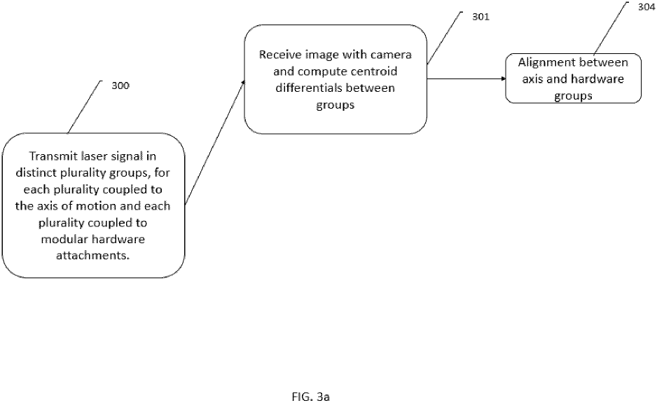

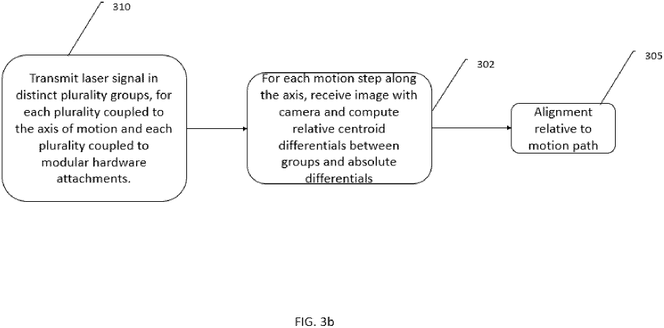

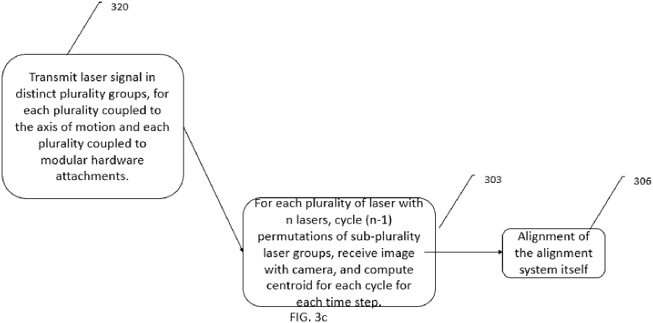

A further description of the invention can be explained with reference to FIG. 3a.

FIG. 3a is a schematic of the system according to an embodiment of the present invention, for real-time self-correcting axial alignment of a machine containing one or more axes. The system allows for three key alignment determinations: alignment of the system between axes of movement and modular hardware attachments, alignment of the system relative to motion path, and alignment of the system to dynamically account for alignment errors over time. Independent groups of lasers emit signals independently (300), one group corresponding to the plurality of lasers coupled to the axis of motion (222, 223, 224 225 in FIG. 2), and one plurality (220, 221) coupled to the modular hardware attachment which contains the probe (260). This effectively represents a group of lasers coupled directly to the axis of motion, and one coupled to the modular hardware attachment. With respect to a common surface normal to the axis of linear motion of the system (270), the laser signals from the two groups that are emitted independently are then received by the camera (230) which contains the common surface in its field of view. The microcontroller (250) then uses computer vision processing in order to compute the centroid of each group, and then subsequently compute the difference between the two centroids (301). Depending on the distance to the common surface upon which the lasers project, the alignment between the axis unit and the modular hardware group (304) is achieved. This effectively gives the alignment between the probe and the axis of linear motion. A similar process is performed for the other system axis.

A further description of the invention can be explained with reference to FIG. 3b.

FIG. 3b is a schematic of the system according to an embodiment of the present invention, for real-time self-correcting axial alignment of a machine containing one or more axes. Independent groups of lasers emit signals independently (300), one group corresponding to the plurality of lasers coupled to the axis of motion (222, 223, 224 225 in FIG. 2), and one plurality (220, 221) coupled to the modular hardware attachment which contains the probe (260). The alignment relative to the path of motion (305) is achieved by computing the centroid differentials between the two laser groups as each axis is advanced (302).

A further description of the invention can be explained with reference to FIG. 3c.

FIG. 3c is a schematic of the system according to an embodiment of the present invention, for real-time self-correcting axial alignment of a machine containing one or more axes. The alignment of the lasers themselves may have errors associated with them that can change as a function of time as well as position. In this case, for each laser group containing n lasers in each group, a subgroup of all permutations of n-1 lasers is pulsed and the projection on a common surface is received by the camera. This allows for the determination of whether a particular laser or set of lasers’ alignment changed with time, and can be compared to previous positional differentials computed in order to quantify this change. Then, the change can be accounted for such that an error signal is generated proportional to this error, and the error is effectively eliminated. This in turn allows for the alignment of the alignment system itself, so that it does not have to be continually calibrated or any such means performed. In addition, a change in camera angle does not affect alignment properties, since the projection geometry differentials on the common surface between the laser groups will remain fixed. This adds robustness to detector angle and alignment. Note that those skilled in the art would recognize that one or more methodologies encompassing, but not limited to those described in FIG. 3a, FIG. 3b, and FIG. 3c can be used simultaneously or independently. Such methodologies can also be implemented with feedback to each other, and that other feedback methodologies may be incorporated.

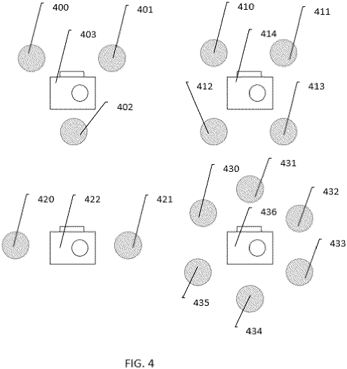

A further description of the invention can be explained with reference to FIG. 4.

FIG. 4 is a diagram of different laser geometries with respect to a camera detector.

This shows a set of laser positions with respect to the camera that are achievable but is by no means an inclusive set of all possibilities. It is shown for the purpose of demonstrating laser geometry. Lasers (400, 401, 402, 410, 411, 412, 413, 420, 421, 430, 431, 432, 433, 434, 434, 435) are shown relative to camera detectors (403, 414, 422, 436) as a projection onto a common plane.

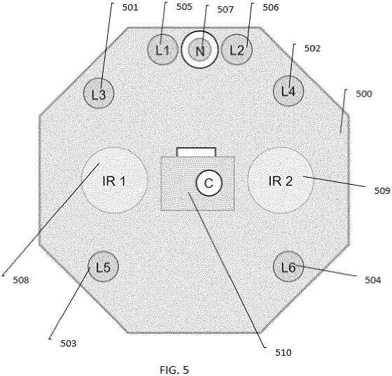

A further description of the invention can be explained with reference to FIG. 5.

FIG. 5 is a diagram of different laser and camera detector geometries with respect to the actuated platform in figure (211). Two laser groups are shown (505, 506 and 501, 502, 503, 504) relative to the actuated platform (500) as well as the camera (510) and modular hardware attachment (507) along with camera infrared lights (508, 509). This is shown as the projection onto the 2D common surface normal to the linear axis of motion in the ideal case that everything was aligned without error.

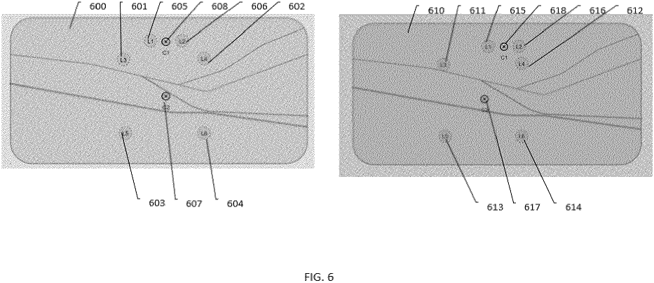

A further description of the invention can be explained with reference to FIG. 6.

FIG. 6 is a diagram of different lasers showing the effect of system misalignment on laser projections. Lasers are projected onto a substrate (600), which contains regions of dark and light material for context reference. Laser alignment is achieved between lasers (601, 602, 603, 604, 605, 606), and the centroids are computed (607, 608). Note that centroid (608) is the projected location of the probe that is fixed by means of the modular hardware attachment. However, lasers (610, 611, 612, 613, 614, 615, 616) are not aligned, which can be noted by the shift in centroids relative to one another (617, 618).

While this invention has been particularly shown and described with reference to example embodiments thereof, it will be understood by those skilled in the art that various changes in form and details may be made therein without departing from the scope of the invention encompassed by the appended claims.

All references cited herein are incorporated herein by reference to the full extent allowed by law. The discussion of those references is intended merely to summarize the assertions made by their authors. No admission is made that any reference (or a portion of any reference) is relevant prior art. Applicants reserve the right to challenge the accuracy and pertinence of any cited reference.

What is claimed is:

1. An alignment device comprising:
at least one or more axis of motion;
a plurality of one or more lasers, wherein each laser is functionally coupled to the axis of motion;
one or more cameras, wherein each camera is functionally coupled to the axis of motion; and
capable of containing modular hardware attachments that are functionally coupled to the axis of motion.

2. The alignment device according to claim 1, wherein the at least one or more axis of motion can be rotational or linear and wherein the linear axes of motion can move in a range 0.1 mm minimum to 100 m maximum.

3. The alignment device according to claim 1, wherein the plurality of lasers can emit any wavelength of light from 100 nm to 1 mm.

4. The alignment device according to claim 1 wherein an alignment between the at least one or more axis of motion and a fixed reference plane can change over some range during device operation.

5. The alignment device according to claim 1 wherein an alignment between plurality of lasers and a fixed reference plane can change over some range during device operation.

6. The alignment device according to claim 1 wherein an alignment between the camera and a fixed reference plane can change over some range during device operation.

7. The alignment device according to claim 1 wherein the modular hardware attachments can accommodate a hollow mechanical probe or object capable of liquid transport through its hollow cavity.

8. An alignment system comprising:
at least one or more axis of motion;
a plurality of one or more lasers, wherein each laser is functionally coupled to the axis of motion;
one or more cameras, wherein each camera is functionally coupled to the axis of motion;
capable of containing modular hardware attachments that attach to the axis of motion; and
allowances for containing feedback between the laser camera and each axis of motion.

9. The alignment system according to claim 8, wherein the at least one or more axis of motion can be rotational or linear and wherein the linear axes of motion can move in a range 0.1 mm minimum to 100 m maximum.

10. The alignment system according to claim 8, wherein the plurality of lasers can emit any wavelength of light from 450 nm to 1 mm.

11. The alignment system according to claim 8 wherein the alignment between the at least one or more axis of motion and a fixed reference plane can change over some range during device operation.

12. The alignment system according to claims 8 wherein the alignment between plurality of lasers and a fixed reference plane can change over some range during device operation.

13. The alignment system according to claims 8 wherein the alignment between the camera and a fixed reference plane can change over some range during device operation.

14. The alignment system according to claim 8, wherein the feedback can be controlled using software and algorithms.

15. The alignment system according to claim 8 wherein the modular hardware attachments can accommodate a hollow mechanical probe or object capable of liquid transport through its hollow cavity.

16. The system according to claim 8 further comprising a microcontroller.

17. The system according to claim 16, wherein the microcontroller might incorporate memory and software algorithms.

18. A method of alignment comprising:
at least one or more axis of motion;
a plurality of one or more lasers, wherein each laser is functionally coupled to the axis of motion;
one or more cameras, wherein each camera is functionally coupled to the axis of motion;
capable of containing modular hardware attachments that attach to the axis of motion; and
a methodology that uses robotic vision data and a first algorithm in order to determine the alignment between the camera, plurality of lasers and axes of motion.

19. The method according to claim 18 wherein the methodology is iterative based on a time frame between 1 nanosecond and 1 hour.

20. The method according to claim 18 wherein the methodology further comprises:
using robotic vision and a second algorithm to calculate the alignment between the modular hardware attachments and a common reference plane.
